(19) United States
(12) Patent Application Publication
(10) Pub. No.: US 2010/0048432 A1
(43) Pub. Date: Feb. 25, 2010

(54) Enhanced oil recovery using sulfonate mixtures

(76) Inventors: Michael T. Costello, Southington, CT (US); Charles F. Irwin, Guilford, CT (US); Qinggao Ma, Naugatuck, CT (US); Naureen Stone, Woodbury, CT (US)

Correspondence Address: Jaimes Sher;Chemtura Corporation, 199 Benson Road, Middlebury, CT, 06749, US

(21) Appl. No.: 12/454,956

(22) Filed: May 26, 2009

Related U.S. Application Data
(60) Provisional application No. 61/091,175, filed on Aug. 22, 2008.

(51) Int. Cl. C09K 8/588; C09K 8/68; C09K 8/584; C09K 8/60

(52) U.S. Cl. 507/224; 507/200; 507/225; 507/259; 507/261; 507/266

(57) ABSTRACT

A surfactant blend of a low molecular weight surfactant and a high molecular weight surfactant to be used in an aqueous flooding. The surfactant blend may be neutralized with an alkali or alkaline agent. The surfactant blend may be mixed with a polymer. Surfactant blends of the present invention increase oil recoveries from oil reservoirs.

### FIELD OF THE INVENTION

The present invention generally relates to methods for enhanced oil recovery and more particularly to tertiary recovery processes using sulfonates.

### BACKGROUND OF THE INVENTION

Crude oil is present within the pores of certain underground rocks. The initial or primary recovery of crude oil uses the pressure within the oil reservoir to drive the crude oil up through the wellbore. During primary recovery only a small percentage of the crude oil in place is extracted, typically around 10% to 30% for most oil reservoirs. Additional amounts of oil can be produced using waterflooding or gas injection, known as secondary recovery. Secondary recovery is relatively inexpensive and effective in producing up to an additional 5% to 20% of crude oil originally in the reservoir. Secondary recovery applies a pressure to the oil reservoir to drive the crude oil up through the wellbore. However, primary and secondary recovery processes can extract less than half of the original oil in the reservoir. Much of the oil that remains is discontinuous and is held in the rocks by very strong capillary forces. Due to costs, most wells are not used after the primary and secondary recovery processes have been completed.

Additional processes to increase the amount of the extracted oil are referred to as enhanced oil recovery (EOR) or tertiary recovery. EOR serves to improve oil displacement by reducing the interfacial tension (IFT) between the oil and water and by restoring the formation pressure to extract the crude oil. Petroliferous The three major types of EOR include chemical or caustic flooding, miscible displacement using carbon dioxide (CO₂) injection or hydrocarbon injection, and thermal recovery using steam flooding or in-situ combustion. Miscible displacement introduces miscible gases into the oil reservoir. Carbon dioxide is most commonly used because the gas reduces the oil viscosity and is less expensive than liquefied petroleum gas. Thermal recovery introduces heat in the oil reservoir to cause the crude oil to reduce its viscosity so that the oil flows toward the wellbore. During thermal recovery crude oil undergoes physical and chemical changes because of the effects of the heat supplied. Physical properties such as viscosity, specific gravity and IFT are altered. The chemical changes involve different reactions such as cracking and dehydrogenation. However, it is costly to build a huge facility and piping system to generate and transport large amounts of CO₂, and many oil fields are located in areas not feasible to build such facilities. Also, CO₂ is mostly suitable for lighter oil fields. While thermal recovery is only suitable for certain fields, particular those with shallow depth and heavy oils.

The other tertiary recovery process involves chemical or caustic flooding. This type of EOR uses an aqueous flood that includes surfactants, polymers and/or caustic compounds. The aqueous flood decreases the IFT and pushes the crude oil from the rock. This crude oil, in the form of immobile, capillary-trapped droplets, can be mobilized by injection of an aqueous flood with surfactants. The surfactants interact with the crude oil to form a micro-emulsion that reduces the capillary trapping forces to a very low level. Once mobilized, the crude oil forms a growing bank that leaves almost no oil behind in the flooded part of the reservoir. After the aqueous flood, the injection may be followed by a cheaper fluid, such as viscous water; and later water alone. The injection of the surfactants, viscous water and water involves the displacement of crude oil to the production well. Several patents and publications have discussed methods for enhanced oil recovery using surfactants.

U.S. Publication No. 2006/0183649 discloses an emulsifier composition that includes at least one natural alkali metal petroleum sulfonate and at least one synthetic alkali metal sulfonate. The emulsifier composition can be combined with a lubricant oil to provide a water-miscible lubricating oil concentrate which forms a stable aqueous emulsion upon the addition thereto of an aqueous medium.

U.S. Publication No. 2004/0248996 discloses an emulsifier composition suitable for mixing with oil to make lubricants. The composition comprises: A) at least one product of the sulfonation of at least one of the following feedstocks: i) a petroleum oil, ii) a straight chain monoalkylbenzene, iii) a straight chain dialkylbenzene, iv) a branched chain monoalkylbenzene, and v) a branched chain dialkylbenzene, and B) at least one straight or branched chain alkylaryl sulfonate salt.

U.S. Pat. No. 7,332,460 discloses an alkylxylene sulfonate for enhanced oil recovery processes. The alkylxylene moiety in the alkylxylene sulfonate contains a high percentage of 4-alkyl-1,2-dimethyl benzene isomer and a high percentage of alkyl group attachment to the xylene ring at positions higher than the 2-position on the alkyl carbon chain.

U.S. Pat. No. 6,989,355 discloses an under-neutralized alkylxylene sulfonic acid composition for enhanced oil recovery processes. The patent also discloses a method for enhancing the recovery of oil from a subterranean reservoir which method employs the under-neutralized alkylxylene sulfonic acid compositions. The under-neutralized alkylxylene sulfonic acid compositions are employed in an aqueous media. The method optionally employs suitable co-surfactants, such as alcohols, alcohol ethers, polyalkylene glycols, poly(oxyalkylene)glycols and/or poly(oxyalkylene)glycol ethers.

U.S. Pat. No. 6,828,281 discloses an aqueous fluid useful for the recovery of a liquid hydrocarbon from subterranean reservoirs comprising an aqueous media and a surfactant blend. The aqueous fluid has an alkaline pH. The surfactant blend comprises at least one synthetic polyisobutylene surfactant and at least one secondary surfactant selected from the group consisting of sulfonate surfactants, alcohols and nonionic surfactants.

U.S. Pat. No. 6,736,211 discloses a method of recovering oil or contaminants from subterranean reservoirs using a surfactant system where an adsorption reducing agent is injected before, after, and/or with the surfactant system. The adsorption reducing agent is formed by the reaction of an olefin sulfonic acid and phenol/aldehyde resin.

U.S. Pat. No. 6,269,881 discloses an oil recovery process which uses a particular class of alkylaryl sulfonate surfactants. The surfactants are derived from an alpha-olefin stream having a broad distribution of even carbon numbers ranging from 12 to 58. The olefin stream is reacted with an aromatic feedstock, such as benzene, toluene, xylene, or a mixture thereof to form alkylates, and then reacted with SO₃ to form sulfonic acids. The resulting surfactant has high solubilization and ultra-low interfacial tension with crude oils, especially waxy crude oil, having a broad distribution of carbon numbers.

U.S. Pat. No. 6,225,267 discloses an emulsifier composition suitable for mixing with oil to form lubricants comprising at least one non-extracted salt of a natural petroleum sulfonic acid having about 15 wt % to about 30 wt % active content; at least one branched chain alkylaryl sulfonic acid or salt thereof; at least one linear alkylaryl sulfonic acid or salt thereof; and optionally at least one other sulfonic acid or salt thereof for adjusting the equivalent weight of the resultant emulsifier composition.

U.S. Pat. No. 6,043,391 discloses anionic surfactants and methods of preparation which are derived from aromatic or substituted aromatic molecules and alkenesulfonic acid. The aryl compound is alkylated and sulfonated in one-step with an alkene sulfonic acid prior to sulfonic acid neutralization.

U.S. Pat. No. 6,022,834 discloses a concentrated surfactant formulation and process for the recovery of residual oil from subterranean petroleum reservoirs, and more particularly an alkali surfactant flooding process which results in ultra-low interfacial tensions between the injected material and the residual oil, wherein the concentrated surfactant formulation is supplied at a concentration above, at, or, below its critical micelle concentration, also providing in situ formation of surface active material formed from the reaction of naturally occurring organic acidic components with the injected alkali material which serves to increase the efficiency of oil recovery.

U.S. Pat. No. 5,049,311 discloses compounds of the formula:

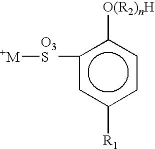

wherein R₁ is an alkyl group, M⁺ is a cation, R₂ is an alkylene oxide and n is an integer from 1 to 4. Surfactant compositions containing these compounds, the process of preparing these compounds as well as the methods of using these surfactant compounds in enhanced oil recovery, as emulsifiers, in emulsion polymerization, as hydrotropes, in foamed drilling fluids, as dye carriers, as textile detergents, as foaming agents for concrete formation and as fiber lubricants are also disclosed.

U.S. Pat. No. 4,873,025 discloses compositions comprising alkylxylene sulfonate compounds of the formula:

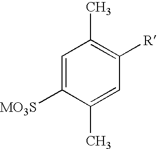

wherein R′ represents a C₆ to C₂₀ alkyl group and wherein M represents a hydrogen, a metal, an alkaline metal ion, an ammonium ion, are useful as surfactants, particularly in enhanced oil recovery techniques.

U.S. Pat. No. 4,692,270 discloses a surfactant obtained by treating a mixture of 20 to 95 wt. % of a thermal cracking oil fraction obtained by thermally cracking a petroleum heavy residual oil at 400° to 700° C., and sulfonating and neutralizing the product. This surfactant is used as a dispersing agent for a coal-oil mixture.

U.S. Pat. No. 4,690,785 discloses an improved low water neutralization energy-saving process for the preparation of an alkylaryl sulfonate by combining an alkylaryl sulfonic acid with a salt-forming base, and utilizing the heat generated during the neutralization reaction to drive off the water present in the reaction mixture.

U.S. Pat. No. 4,608,204 discloses a process for the preparation of a low viscosity aqueous alkyl toluene or alkyl xylene sulfonate which comprises neutralizing alkyl toluene or alkyl xylene sulfonic acid with aqueous sodium hydroxide in the presence of sufficient sodium chloride to lower the viscosity of the sulfonate salt produced. Alternatively, the sodium chloride may be added subsequent to neutralization of the sulfonic acid.

U.S. Pat. No. 4,536,301 discloses that the recovery of residual oil which is found in subterranean reservoirs may be accomplished by utilizing an aqueous surfactant slug to reduce the interfacial tension between oil and water. An effective surfactant slug which may be used will comprise a mixture of: (1) from about 1 to about 10% of a sulfonate of a mixture of mono- and dialkyl-substituted aromatic hydrocarbon which has been obtained by the alkylation of an aromatic hydrocarbon with an olefinic hydrocarbon in the presence of a hydrogen fluoride catalyst; (2) a lower alkyl alcohol which possesses from about 3 to about 6 carbon atoms; and (3) a nonionic cosurfactant comprising an ethoxylated n-alcohol which possesses from about 12 to about 15 carbon atoms.

U.S. Pat. No. 4,414,119 discloses adding an alkylbenzene sulfonate to a crude oil sulfonation product to prevent the formation of insoluble precipitants in the crude oil sulfonation product. The use of an alkylbenzene sulfonate as an additive to a microemulsion slug containing crude oil sulfonation product improves the injectivity of the microemulsion slug and prevents substantial plugging of the fluid injection system and the subterranean oil-bearing formation by insoluble precipitants in the microemulsion.

U.S. Pat. No. 4,180,691 discloses an improved process for the acid-catalyzed alkylation of C₆ to C₉ aromatic hydrocarbons with olefins to produce linear alkylaromatic hydrocarbons useful as detergent precursors. The alkylation reaction is performed in the presence of a surfactant to reduce the 2-phenyl isomer content of the product linear alkylaromatic hydrocarbons.

U.S. Pat. No. 4,177,207 discloses petroleum sulfonates yielding improved results in enhanced oil recovery processes that are comprised of a reaction product obtained from a mixture of a major proportion of a petroleum oil feed stock, such as a crude or a portion thereof, and a minor proportion of an additive, such as an oxygenated hydrocarbon, i.e., an oxo-alcohol or the like, reacted with SO₃ under sulfonation conditions, mixed with about 0.5 to 20% (by reaction mixture weight) of water at the temperature in the range of about 50° to 150° C. for a relatively brief period of time and then neutralizing the resultant material with a base, such as NaOH. The neutralized petroleum sulfonated material thus obtained, which may or may not be extracted to remove unsulfonated organic material or salts, is then formulated into a slug for injection into an oil field for enhanced oil recovery.

U.S. Pat. No. 4,140,642 discloses emulsifier compositions, suitable for mixing with mineral oil to form metal working lubricants, that comprise a mixture of salts of alkylaryl sulfonic acids, said acids having a molecular weight distribution with two distinct peaks, one peak being preferably in the range of 270 to 400, while the other peak is in the range of 350 to 600; which peaks differ by at least 80. Mixtures of 5 to 95 wt. % sodium salts of branched chain C₁₂ to C₁₆ alkyl orthoxylenesulfonic acids with 95 to 5 wt. % sodium salts of branched chain C₂₀ to C₂₈ alkyl benzenesulfonic acids are disclosed.

U.S. Pat. No. 4,004,638 discloses recovery of oil from subterranean oil reservoirs by waterflooding employing an alkaline agent and a sulfonate surfactant. An aqueous initiation slug containing an alkaline agent selected from the group consisting of alkali metal and ammonium hydroxides is injected into the reservoir via a suitable injection system. Thereafter an aqueous surfactant slug is injected into the reservoir behind the initiation slug. The surfactant slug contains a sulfonate surfactant and an alkaline agent. Subsequent to injection of the surfactant slug, an aqueous flooding medium is injected in order to displace the oil within the reservoir to a production system from which it is recovered. A portion of the flooding medium may contain a thickening agent for mobility control purposes.

U.S. Pat. No.3,997,451 discloses oil recovery by flooding oil-bearing subterranean formations with an aqueous mixture, preferably a micellar dispersion, comprised of at least two different petroleum sulfonates, the sulfonates have an equivalent weight within the range of about 390-450, and have an aliphatic to aromatic proton (A/AP) ratio within the range of 4-20 moles per mole but the two sulfonates have a difference in their respective A/AP ratio of at least 2.5 moles per mole.

U.S. Pat. No. 3,933,201 discloses that an improved anionic waterflood additive is prepared by alkylating an aromatic hydrocarbon such as benzene with a branched-chain alkene having about 10 to about 35 carbon atoms such as a propylene tetramer dimerization reaction product in the presence of an alkylation catalyst such as AlCl₃; sulfonating the thus formed alkylate product or a fraction thereof to form a sulfonic acid; converting the sulfonic acid to a sulfonate by reacting with a base component such as an alkali metal hydroxide, ammonium hydroxide, or an alkali metal carbonate; and overbasing the sulfonate by admixing with an excess of base component. The anionic waterflood additive is injected into a petroliferous formation, the formation is waterflooded, and oil is recovered.

U.S. Pat. No. 3,847,823 discloses an overbased anionic waterflood additive comprising a water-soluble low molecular weight alkali metal hydrocarbon sulfonate having a molecular weight of about 200 to about 400 plus a water insoluble high molecular weight alkali metal hydrocarbon sulfonate having a molecular weight of about 400 to about 600 plus an overbased amount of base component such as an alkali metal hydroxide. The additive is prepared and injected into a petroliferous formation to improve a waterflood process.

U.S. Pat. Nos. 2,467,132 and 2,467,131 disclose a group of alkylaromatic sulfonic acids and their salts useful as surface active agents, particularly as detergents and wetting agents.

The entire disclosures and contents of the patents and publications listed above are hereby incorporated by reference.

Because of the costs involved in using tertiary recovery techniques, it is important to select a process that is highly efficient. Even with improvements in conventional EOR techniques, with current technology less than 33% of the oil can be extracted using such EOR techniques. There is a strong need in the marketplace of a suitable surfactant system for chemical flooding.

### SUMMARY

In a first aspect of the present invention there is provided a surfactant composition comprising a water-soluble surfactant having an equivalent weight of from 200 to 460, wherein at least 60% of the water-soluble surfactant has a molecular weight within 15 g/mole of the equivalent weight of the water-soluble surfactant and an oil-soluble surfactant having an equivalent weight of 300 to 700 moles, wherein less than 40% of the oil-soluble surfactant has a molecular weight within 15 g/mole of the equivalent weight of the oil-soluble surfactant.

In a second aspect of the present invention there is provided a surfactant composition comprising a water-soluble surfactant having an equivalent weight of 200 to 460, and an oil-soluble surfactant having an equivalent weight of 300 to 700, wherein the molecular weight distribution of the water-soluble surfactant is narrower than the molecular weight distribution of the oil-soluble surfactant.

In a third aspect of the present invention there is provided a method for recovering entrained crude oil from an oil reservoir, the method comprising (a) injecting into the oil reservoir a surfactant composition comprising (i) water; (ii) a water-soluble surfactant having an equivalent weight of 200 to 460, wherein at least 60% of the water-soluble surfactant has a molecular weight within 15 g/mole of the equivalent weight of the water-soluble surfactant; and (iii) an oil-soluble surfactant having an equivalent weight of 300 to 700, wherein less than 40% of the oil-soluble surfactant has a molecular weight within 15 g/mole of the equivalent weight of the oil-soluble surfactant, and (b) displacing the entrained crude oil with the surfactant composition.

In a fourth aspect of the present invention there is provided a surfactant composition comprising a synthetic linear alkylaryl anionic surfactant having an equivalent weight of 200 to 460, wherein at least 60% of the synthetic linear alkylaryl anionic surfactant has a molecular weight within 15 g/mole of the equivalent weight of the synthetic linear alkylaryl anionic surfactant, and a petroleum surfactant having an equivalent weight of 300 to 700, wherein less than 40% of the petroleum surfactant has a molecular weight within 15 g/mole of the equivalent weight of the petroleum surfactant.

In a fifth aspect of the present invention there is provided a surfactant composition for enhanced oil recovery comprising a synthetic linear alkylaryl anionic surfactant having an equivalent weight of 200 to 460, and a petroleum surfactant having an equivalent weight of 300 to 700, wherein the molecular weight distribution of the synthetic linear alkylaryl anionic surfactant is narrower than the molecular weight distribution of the petroleum surfactant.

In a sixth aspect of the present invention there is provided a method for recovering entrained crude oil from an oil reservoir, comprising (a) injecting into the oil reservoir a surfactant composition comprising: (i) water; (ii) a synthetic linear alkylaryl anionic surfactant having an equivalent weight of 200 to 460, wherein at least 60% of the synthetic linear alkylaryl anionic surfactant has a molecular weight within 15 g/mole of the equivalent weight of the synthetic linear alkylaryl anionic surfactant; and (iii) a petroleum surfactant having an equivalent weight of 300 to 700, wherein less than 40% of the petroleum surfactant has a molecular weight within 15 g/mole of the equivalent weight of the petroleum surfactant; and (b) displacing the entrained crude oil with the surfactant composition.

In a seventh aspect of the present invention there is provided a surfactant composition comprising a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and a second synthetic surfactant having an equivalent weight of 300 to 700, wherein less than 40% of the second synthetic surfactant has a molecular weight within 15 g/mole of the equivalent weight of the second synthetic surfactant.

In a eighth aspect of the present invention there is provided a surfactant composition comprising a first synthetic linear alkylaryl anionic surfactant having an equivalent weight of 200 to 460, and a second synthetic surfactant having an equivalent weight of 300 to 700, wherein the molecular weight distribution of the first synthetic linear alkylaryl anionic surfactant is narrower than the molecular weight distribution of the second synthetic surfactant.

In a ninth aspect of the present invention there is provided a method for recovering entrained crude oil from an oil reservoir, the method comprising: (a) injecting into the oil reservoir a surfactant composition comprising: (i) water; (ii) a synthetic linear alkylaryl anionic surfactant having an equivalent weight of 200 to 460, wherein at least 60% of the synthetic linear alkylaryl anionic surfactant has a molecular weight within 15 g/mole of the equivalent weight of the synthetic linear alkylaryl anionic surfactant; and (iii) a petroleum surfactant having an equivalent weight of 300 to 700, wherein less than 40% of the petroleum surfactant has a molecular weight within 15 g/mole of the equivalent weight of the petroleum surfactant; and (b) displacing the entrained crude oil with the surfactant composition.

In a tenth aspect of the present invention there is provided a surfactant composition comprising a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and a second synthetic surfactant having an equivalent weight of 300 to 700, and selected from the group consisting of linear alkylaryl sulfonates, linear dialkylaryl sulfonates and linear alkane sulfonates.

In a eleventh aspect of the present invention there is provided a method for recovering entrained crude oil from an oil reservoir comprising: (a) injecting into the oil reservoir a surfactant composition comprising: (i) water; (ii) a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and (iii) a second synthetic surfactant having an equivalent weight of 300 to 700, and selected from the group consisting of linear alkylaryl sulfonates, linear dialkylaryl sulfonates and linear alkane sulfonates; and (b) displacing the entrained crude oil with the surfactant composition.

### BRIEF DESCRIPTION OF DRAWINGS

The foregoing and other objects and advantages of our invention will appear more fully from the following description, made in connection with the accompanying drawings of non-limiting preferred embodiments of the inventions, wherein like characters refer to the same or similar parts throughout the views, and in which:

FIG. 1 shows the molecular weight distribution of an water-soluble surfactant in accordance with an embodiment of the present invention;

FIG. 2 shows the molecular weight distribution of an oil-soluble petroleum surfactant in accordance with an embodiment of the present invention;

FIG. 3 shows the molecular weight distribution of a composition according to one exemplary embodiment of the invention; and

FIG. 4 shows the molecular weight distribution of a composition according to another exemplary embodiment of the invention.

### DETAILED DESCRIPTION OF THE INVENTION

The present invention is generally directed to improved surfactant compositions, e.g., surfactant mixtures, surfactant slugs, and micellar solutions, suitable for use with aqueous flooding for tertiary recovery of crude oil from oil reservoirs. The compositions of the present invention overcome the capillary force holding the oil in the rock, in part, by lowering the interfacial tension (IFT) to thereby improve oil recovery rates. For example, approximately 1 kg of surfactant compositions of the present invention may recover about 1 barrel (159 liters) of oil. The surfactant compositions of the present invention comprise a water-soluble surfactant and an oil-soluble surfactant, each preferably having a specific equivalent weight and molecular weight distribution that, in combination, have been found to be surprisingly effective in tertiary oil recovery, as described in greater detail below.

The compositions of the invention preferably have an equivalent weight, i.e., average equivalent weight, of from 250 to 550 g/mole, e.g., from 300 to 500 g/mole or from 350 to 450 g/mole. For purposes of the present specification and claims, the equivalent weight is determined by ASTM D-3712, and the molecular weight distribution is determined by Mass Spectrum and Liquid Chromatogram. For purposes of the invention, the equivalent weight generally corresponds to number average molecular weight (Mₙ) determined by Mass Spectrum.

The weight ratio of the water-soluble surfactant to the oil-soluble surfactant in the composition may vary widely, depending, for example, on the properties of the target oil reserve. In some preferred embodiments, the weight ratio of the water-soluble surfactant to the oil-soluble surfactant ranges from 9:1 to 1:9, e.g., from 8:2 to 2:8 or from 3:7 to 7:3.

In another embodiment, the invention is directed to an aqueous flood comprising any of the surfactant compositions (e.g., the syn-nat composition or the syn-syn composition, discussed below) of the invention in an amount ranging from 0.01 to 2.0 wt %, e.g., from 0.1 to 1.5 wt % or from 0.5 to 1.0 wt %, based on the total mass of the aqueous flood. The aqueous flood, for example, may be directed to an oil reservoir for tertiary recovery, as described above.

### Water-Soluble Surfactants

The water-soluble surfactants, e.g., sulfonates, employed in the present invention are selected from surfactants having an equivalent weight of from 200 to 460 g/mole, e.g., from 250 to 450 g/mole or from 290 to 400 g/mole. Suitable water-soluble surfactants include, for example, synthetic anionic linear alkylaryl sulfonates such as linear alkylbenzene sulfonates, linear alkyltoluene sulfonates, linear alkylxylene sulfonates, and linear alpha olefin sulfonates. Alkali sulfonates are preferred, such as sodium sulfonates. Sodium dodecylbenzene sulfonate and sodium dodecyl ortho-xylene sulfonate are preferred water-soluble sulfonates. The alkyl groups may have, for example, from 1 to 20 carbon atoms, e.g., from 6 to 16 carbons atoms or from 8 to 14 carbon atoms.

The water-soluble surfactants, e.g., sulfonates, ideally also have a narrow distribution of molecular weights. In one embodiment, the water-soluble surfactants, e.g., water-soluble sulfonates, have a narrow molecular weight distribution in which at least 60% of the water-soluble surfactants have a molecular weight that is within 15 g/mole of the equivalent weight of the water-soluble surfactants.

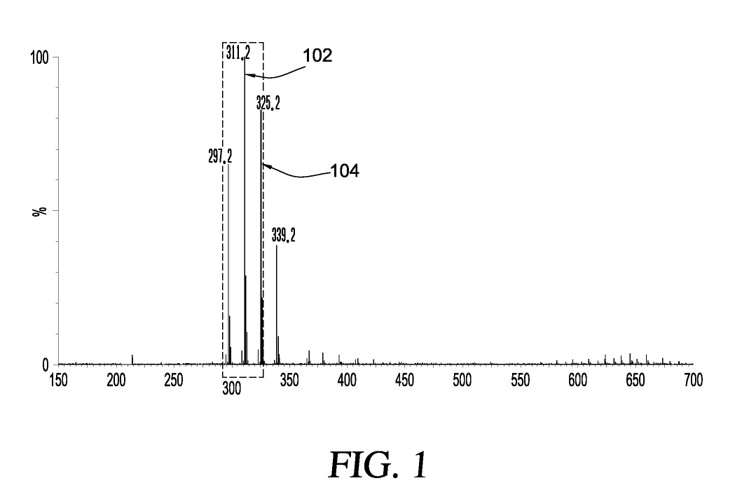

A non-limiting example of a water-soluble surfactant having a narrow molecular weight distribution is shown in FIG. 1, where the equivalent weight 102 is 311 g/mole and at least 60% of the water-soluble surfactants are within 15 g/mole of the equivalent weight 102, defined by bounded area 104. In another embodiment, the water-soluble surfactants have a narrow molecular weight distribution such that at least 60%, e.g., at least 70% or at least 80%, of the water-soluble surfactants have a molecular weight that is within 15 g/mole of the equivalent weight of the water-soluble surfactants. Without being bound to theory, it is believed that the molecular weight distribution of water soluble linear sulfonates provides dense packing of the surfactants between the water-oil phase to get ultra low IFT at low concentration.

Exemplary water-soluble sulfonates include Witconic™ 1298 soft acid sodium salt (EW=311) made by Akzo Nobel Corporation, dodecylbenzenesulfonic acid sodium salt (EW=348), Neodol™ IOS1517 Internal Olefin Sulfonate (EW=328) made by Shell, and AOS-12 (alpha olefin sulfonate) (EW=270) made by Shell.

### Oil-Soluble Surfactants

The oil-soluble surfactants employed in the present invention are selected from surfactants having an equivalent weight of from 300 to 700 g/mole, e.g., from 350 to 600 g/mole or from 400 to 500 g/mole. Suitable oil-soluble surfactants include, for example, petroleum sulfonates, also known as natural sulfonates, and synthetic sulfonates. The synthetic oil-soluble sulfonates may include linear alkylaryl and dialkylaryl sulfonates, branched alkylaryl and dialkylaryl sulfonates, linear alkane sulfonates, branched alkane sulfonates, and mixtures thereof. Alkali sulfonates are preferred, such as sodium sulfonates. The alkyl groups may have from 8 to 40 carbon atoms, e.g., from 10 to 25 carbons atoms or from 12 to 20 carbon atoms.

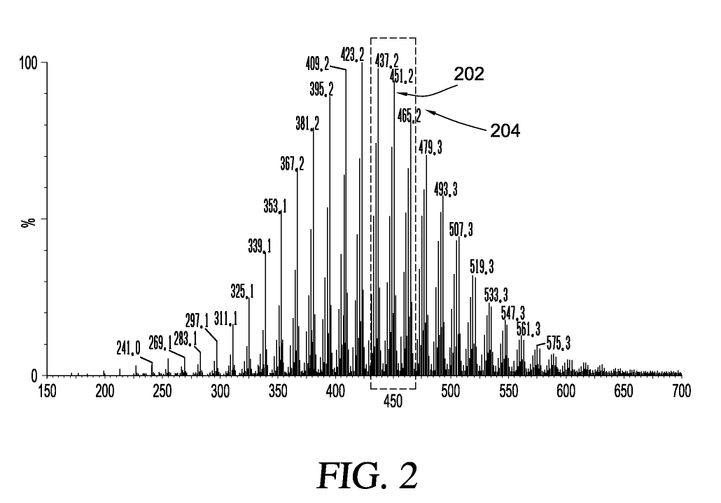

Normally, petroleum sulfonates have a molecular weight distribution that is broader than synthetic oil-soluble sulfonates and synthetic water-soluble sulfonates. In one embodiment, the composition comprises a petroleum sulfonate having a molecular weight distribution in which less than 40% of the petroleum sulfonate has a molecular weight that is within 15 g/mole of the equivalent weight of the petroleum sulfonate. An example of such a distribution is shown in FIG. 2, where the equivalent weight 202 is 451 g/mole and less than 40% of the surfactants are within 15 g/mole of such equivalent weight 202, as indicated by bounded area 204. In another embodiment, the petroleum sulfonates have a wide distribution of molecular weights such that less than 40%, e.g., less than 35%, or less than 30% of the surfactants have a molecular weight that is within 15 g/mole of the equivalent weight. Without being bound by theory, it is believed that by employing an oil-soluble sulfonate having a broad molecular weight distribution, the compositions of the invention have improved versatility for recovering a broad range of entrained oils. For example, oil-soluble surfactants, including petroleum sulfonates and synthetic oil-soluble sulfonates, having a wide molecular weight distribution desirably interact well with both the light and heavy components of crude oil.

In one embodiment, for synthetic oil-soluble sulfonates, the distribution of molecular weights preferably is such that less than 50%, e.g., less than 40%, or less than 30%, of the synthetic oil-soluble sulfonates have a molecular weight that is within 15 g/mole of the equivalent weight of the synthetic oil-soluble sulfonates. In another embodiment, the synthetic oil-soluble sulfonates may comprise two or more synthetic oil-soluble sulfonates that have been blended together to form a combined synthetic oil-soluble sulfonate having a wide molecular weight distribution. Thus, the composition may comprise a synthetic oil-soluble sulfonate in which less than 50%, e.g., less than 40%, or less than 30% of the (combined) synthetic oil-soluble sulfonate have a molecular weight that is within 15 g/mole of the equivalent weight of the synthetic oil-soluble sulfonate. Thus, in this context, the term “synthetic oil-soluble sulfonates” includes all synthetic oil-soluble sulfonates, whether the composition comprises a single unblended synthetic oil-soluble sulfonate or, if the composition comprises a blend of synthetic oil-soluble sulfonates, from the combined synthetic oil-soluble sulfonates. When using a blend of two or more synthetic oil-soluble sulfonates, the molecular weights preferably are sufficiently different so as to cover a wide range of molecular weights. In this manner, the oil-soluble synthetic sulfonate blend may better simulate a petroleum sulfonate than using only one of the synthetic sulfonates.

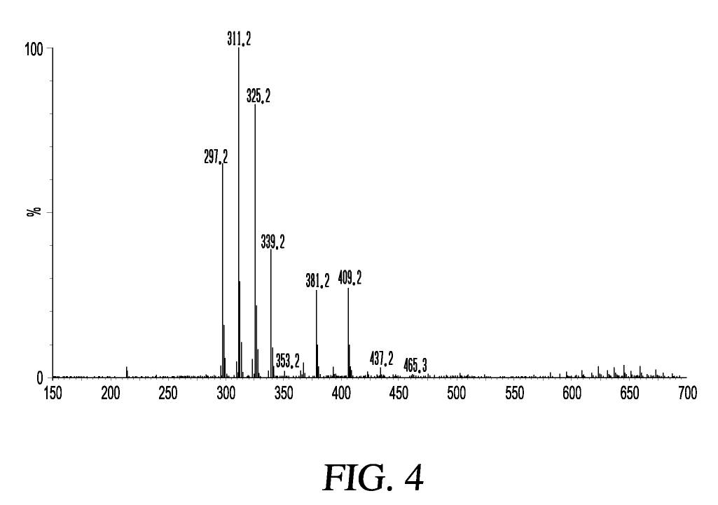

In another embodiment, the synthetic oil-soluble surfactants are selected from linear alkylaryl sulfonates, linear dialkylaryl sulfonates and linear alkane sulfonates. The equivalent weight of the synthetic oil-soluble surfactants is from 300 to 700, e.g., from 350 to 600 or from 400 to 500, and is most preferrably less than 500. Preferably the linear alkyl primarily comprise C₁₆ and C₁₈ chains, e.g., in an amount greater than 50 wt %, greater than 60 wt % or greater than 70 wt %. In one embodiment, for this type of linear synthetic oil-soluble sulfonates, the distribution of molecular weights preferably is such that greater than 70%, e.g., greater than 80% or greater than 90%, of the linear synthetic oil-soluble sulfonates have a molecular weight that is within 30 g/mole of each other. In this embodiment, the linear synthetic oil-soluble sulfonate optionally has an equivalent weight ranging from 420 to 440, e.g., about 430. Preferably, such linear synthetic oil-soluble sulfonates may have two distinct peaks as determined by mass spectrometry, as shown, for example, in FIG. 4.

Petroleum sulfonates are typically produced as a by-product of refining processes in which certain highly refined petroleum products such as white lubricating oils, medicinal oils, and certain grades of transformer oils are produced, as described in U.S. Publication No. 2006/0183649 and U.S. Publication No. 2004/0248996, the entireties of which are incorporated herein by reference. The highly refined petroleum products are produced by treating a refined petroleum distillate or raffinate with fuming sulfuric acid, which reacts with certain components of the oil to produce sulfonic acids, some of which are oil-soluble and some of which are water-soluble, thus forming a two-phase system. The two phases separate into two layers, one of which is the oil layer containing the oil-soluble reddish-brown or mahogany sulfonic acids, and one of which is the water-soluble layer, commonly referred to as an acid sludge layer, that contains resinous materials, unreacted sulfuric acid, and water-soluble or green sulfonic acids. The layers are then separated and the oil-soluble sulfonic acids are recovered from the oil layer, usually in the form of their sodium salts.

In one embodiment, the natural petroleum sulfonic acid/salt optionally employed in the practice of the present invention is prepared by the sulfonation of aromatics contained in natural petroleum, e.g., a typical lube base oil of 15-400 cSt viscosity at 40° C. The acid oil may be de-sludged by gravity settling and neutralized with any monovalent cation from a base, preferably sodium. Preferably, the product is not extracted or solvent-treated to remove oil or salts. The process can thus be simplified over previously used processes for preparing natural petroleum sulfonic acid salts for use in emulsifier compositions.

In one embodiment, the natural petroleum sulfonic acid or sulfonate salt is prepared using sulfuric acid, oleum (e.g., fuming sulfuric acid) and/or sulfur trioxide or other sulfonating agents to sulfonate petroleum oil, preferably a paraffinic oil. One preferred oil for use herein is a typical lube base oil of 15-4000 cSt at 40° C. The acid oil is de-sludged by settling using natural gravitational forces and is subsequently neutralized to about a 15-30%, preferably about a 20-30%, active petroleum sulfonate in oil. No further extraction or processing for the removal of oil or salts is necessary. These non-extracted natural sulfonates, as neutral salts, provide corrosion protection properties to metal and assist in emulsification performance.

The natural petroleum sulfonates are easy to produce owing to the minimum amount of processing required. The preferred high aromatic containing oil is in abundant supply. The sulfonates can be blended with other sulfonate emulsifiers to produce a product of preferably 60% or greater active content, for instance with highly active sulfonic acids. An example of a natural sodium petroleum sulfonate of this type is sodium petroleum sulfonate Petronate H having a 62% active sulfonic acid salt supplied by Chemtura Corp.

A preferred example of a natural petroleum product that can be sulfonated is commercially available from ExxonMobil Corporation under the designation EXXON 3278, which is understood to be a blend of paraffin and sulfonatable alkylarenes. One means for preparing sulfonated EXXON 3278 is as follows. First the feedstock (EXXON 3278) is subjected to an over-sulfonation in an impact jet reactor. While the over-sulfonation process yields the maximum amount of active product, it also results in the formation of a significant quantity of the disulfonate product, a component of “sludge.” To remove this sludge, the acid stream coming out of the reactor is mixed with heptane (to solubilize the active and the free oil) and concentrated sulfuric acid (to solubilize the sludge). Upon standing, the sulfuric acid/sludge layer separates and is removed, and the heptane product layer is washed with water to reduce its free sulfuric acid content. This product layer is then neutralized and the heptane is removed by distillation.

Other methods of producing petroleum sulfonates include, but are not limited, those methods described in U.S. Pat. Nos. 4,147,638, 4,252,192 and 4,847,018, the entireties of which are incorporated herein by reference.

The petroleum sulfonic acid salts may be either inorganic or organic. The preferred inorganic salts are sodium salts. However, ammonium salts, or those of other metals, especially alkali or alkaline earth metals, can also be used. Inorganic compounds that can be employed include, but are not limited to, those comprising barium, calcium, lithium, rubidium, cesium, magnesium, potassium, sodium, strontium, radium, zinc, iron, copper, aluminum, and the like. Sodium is, however, the preferred metal for use herein. Organic bases that can be employed include nitrogen bases, for example, primary, secondary, or tertiary amines, polyamines, alkanolamines including monoethanolamine, diethanolamine, triethanolamine, mixtures thereof, and the like.

Exemplary petroleum sulfonates include Petronate™ L (EW=430), Petronate™ HL/L (EW=440), Petronate™ HL (EW=460), Petronate™ 480 (EW=480), Petronate™ H (EW=500), Petronate™ HH (EW =550) made by Chemtura Corporation, Petrosul™ 60 (EW=470-550) made by Penerco, SULFOMED™ A-450 (EW=450), SULFOMED™ A-475 (EW=475), SULFOMED™ A-500 (EW=500) made by Aceites Especiales Del Mediterraneo, S.A. (Aemedsa), and 600 SUS petroleum oil typically made from Exxon Americas Core 600 (EW 550-580), Sulfol™ 430, Sulfol™ 465 made by Matsumura Oil Research Co., and natural sodium sulfonate made by Zhuhai DaCheng Chemical Co.

Exemplary synthetic oil-soluble sulfonates include sulfonic acid-sodium salt (EW=430) made from H-250 by Huntsman Corporation, sulfonic acid-sodium salt (EW =480) made from Alchisor™ DE by Sasol Olefins & Surfactants GmbH, Aristonate™ L (EW=430), Aristonate™ M (EW=460), Aristonate™ H (EW=520) made by Pilot Chemical, Synacto™ 246 (EW=520) made by Infineum.

### Preferred Surfactant Compositions

In a first aspect of the present invention, the surfactant composition, e.g., surfactant slug, comprises a water soluble synthetic linear alkylaryl sulfonate having an equivalent weight of from 200 to 460 g/mole, e.g., from 250 to 450 g/mole or from 290 to 400 g/mole and a oil soluble petroleum sulfonate having an equivalent weight of from 300 to 700 g/mole, e.g., from 350 to 600 g/mole or from 400 to 500 g/mole. Such compositions are generally referred to herein as syn-nat (synthetic-natural) compositions. By linear it is meant that the olefins used to make the sulfonates are from n-paraffins or ethylene oligomer based alpha olefin.

The syn-nat composition preferably has an overall equivalent weight of from 250 to 550 g/mole, e.g. from 300 to 500 g/mole or from 350 to 450 g/mole. The molecular weight distribution for the synthetic linear alkylaryl sulfonate preferably is narrower than molecular weight distribution for the petroleum sulfonate. In such embodiments, the synthetic linear alkylaryl sulfonate ideally has a narrow molecular weight distribution such that at least 60%, e.g., at least 70% or at least 80% of the synthetic linear alkylaryl sulfonate has a molecular weight that is within 15 g/mole of the equivalent weight of the synthetic linear alkylaryl sulfonate.

The petroleum sulfonates preferably have a wide molecular weight distribution such that less than 40%, e.g., less than 35% or less than 30% of the petroleum sulfonates have a molecular weight that is within 15 g/mole of the equivalent weight of the petroleum sulfonates. The ratio of synthetic linear alkylaryl sulfonate to petroleum sulfonate in the syn-nat composition preferably ranges from 1:9 to 9: 1, e.g., from 8:2 to 2:8 or from 4:6 to 6:4.

In a second aspect of the invention, the surfactant composition comprises a first water soluble synthetic linear alkylaryl sulfonate having an equivalent weight of from 200 to 460 g/mole, e.g., from 250 to 450 g/mole or from 290 to 400 g/mole and a second oil soluble synthetic sulfonate having an equivalent weight of from 300 to 700 g/mole, e.g., from 350 to 600 g/mole or from 400 to 500 g/mole. Such a surfactant compositions are generally referred to herein as syn-syn (synthetic-synthetic) compositions. The syn-syn composition preferably has an overall equivalent weight of from 250 to 550 g/mole, e.g., from 300 to 500 g/mole or from 350 to 450 g/mole. The molecular weight distribution for the first synthetic linear alkylaryl sulfonate preferably is narrower than the second synthetic sulfonate. In such embodiments, the first synthetic linear alkylaryl sulfonate has a narrow molecular weight distribution such that at least 60%, e.g., at least 70% or at least 80%, of the synthetic linear alkylaryl sulfonate has a molecular weight that is within 15 g/mole of the equivalent weight of the first synthetic linear alkylaryl sulfonate. Also, the second synthetic sulfonate preferably has a wide molecular weight distribution such that less than 50%, e.g., less than 40% or less than 30%, of the second synthetic sulfonate has molecular weight that is within 15 g/mole of the equivalent weight of the second synthetic sulfonate.

The ratio of first synthetic linear alkylaryl sulfonate to second synthetic sulfonates in such syn-syn compositions, for example, may be from 9:1 to 1:9, e.g. 8:2 to 2:8 or 7:3 to 3:7.

In a third aspect of the invention, the syn-syn composition comprises a first water soluble synthetic linear alkylaryl sulfonate having an equivalent weight of from 200 to 460 g/mole, e.g., from 250 to 450 g/mole or from 290 to 400 g/mole, and a second oil soluble synthetic linear sulfonate having an equivalent weight of from 300 to 700 g/mole, e.g., from 350 to 600 g/mole or from 400 to 500 g/mole, wherein the second synthetic linear sulfonate are selected from the group consisting of linear alkylaryl sulfonates, linear dialkylaryl sulfonates and linear alkane sulfonates. In such embodiments, the first synthetic linear alkylaryl sulfonate has a narrow molecular weight distribution such that at least 60%, e.g., at least 70% or at least 80%, of the synthetic linear alkylaryl sulfonate has a molecular weight that is within 15 g/mole of the equivalent weight of the first synthetic linear alkylaryl sulfonate. A preferred ratio of first surfactants to second surfactants for this syn-syn composition is 8:2.

### Interfacial Tension

One advantage of using surfactant mixtures, e.g., the syn-nat and syn-syn compositions, of the present invention is that oil recoveries of from 10 to 50%, e.g., from 15 to 40% or from 20 to 35%, of the crude oil in the oil reservoir (after primary and secondary recovery) may be recovered.

The surfactant mixtures of the present invention reduce the interfacial tension (IFT) thereby allowing more oil to be recovered in addition to oil recovered by primary and secondary recovery techniques. IFT refers to the surface free energy that exists between two immiscible liquid phases, such as oil and water. The energy barrier produced by IFT prevents one liquid from becoming emulsified into the other. To form an emulsion, surface free energy must be lowered by adding a third component, such as a surfactant, that seeks the interface. In most oil reservoirs the IFT between the oil and water is approximately 30 to 60 dynes/cm (30 to 60 mN/m). To recover the oil, the IFT should be lowered to approximately less than 10⁻² to 10⁻³ dynes/cm.

The importance of reducing the IFT is shown by the following equation that represents the competition between the capillary forces and viscous force of the aqueous flood.

$${N}_{Ca} = \frac{{μ}_{w} {U}_{w}}{γ φ}$$

N_{ca} is a capillary number (dimensionless number), μ_{w} is the flood viscosity, U_{w} is the flood velocity, φ is the porosity factor of rock (unalterable) and γ is the IFT. The calculated value of N_{ca} that achieves greatest efficiency in mobilizing oil is approximately 10⁻² to 10⁻³. For comparison, secondary recovery achieves a N_{ca} value of approximately 10⁻⁶ to 10⁻⁷. Since there are practical difficulties in increasing either the flood viscosity or velocity, the IFT needs to be reduced. Thus, a lower IFT corresponds to a higher oil recovery.

As indicated above, the embodiments of the present invention use a mixture of water-soluble surfactants, e.g., sulfonates, and oil-soluble surfactants, e.g., sulfonates. The water-soluble surfactants preferably are capable of lowering the IFT below 0.03 dynes/cm, e.g., below 0.02 dynes/cm or below 0.01.dynes/cm. The oil-soluble surfactants facilitate the removal of crude oil soluble residues from the oil reservoir. In addition, oil-soluble surfactants also are capable of lowering the IFT to below 0.03 dynes/cm, e.g., below 0.02 dynes/cm or below 0.01 dynes/cm. While water-soluble surfactants and oil-soluble surfactants may lower the IFT when used alone in an aqueous flood, the combination of the two surfactants produces a surprising and unexpected result to achieve ultra-low IFTs of, for example, less than 0.01 dynes/cm, e.g., less than 0.005 dynes/cm or less than 0.002 dynes/cm.

### Additive Components

In another embodiment, the aqueous flood includes a surfactant-polymer blend in addition to water and the compositions of the present invention. For example, the surfactant mixtures, e.g., syn-nat and syn-syn compositions of the invention, may be combined with a polymer and added to water to form the aqueous flood. Suitable polymers include, for example, poly(acrylamide), poly(acrylic acid) alkali metal salt, partially hydrolyzed poly (acrylamide) and other water soluble, non-Newtonian, high molecular weight polymers. In one embodiment, the polymer of the surfactant-polymer blend is selected to avoid unfavorable interactions between the surfactants and polymer. The polymer preferably forms a stable liquid phase with the surfactants so that no additional alcohols or other solvents are necessary to prevent the surfactants from precipitating and plugging the oil reservoir. The polymer may increase the viscosity of the liquid phase to increase the flow of the surfactants resulting in good contact with the crude oil held in the rock by the capillary force. Additionally, the polymer beneficially may induce the formation of micelles. In such embodiments, the polymer may be present in the aqueous flood in an amount from 0.01 to 1.0 wt %, e.g., from 0.05 to 0.5 wt % or from 0.1 to 0.2 wt %, based on the total mass of the aqueous flood.

The water-soluble or oil-soluble surfactants may be neutralized with an alkali or alkaline agent. Suitable alkali and alkaline agents include alkali hydroxides, carbonates, and chlorides, such as sodium hydroxide, sodium chloride, potassium hydroxide, calcium carbonate, magnesium hydroxide, and combinations thereof. In one embodiment, the alkali or alkaline agents are added to the surfactant composition prior to being pumped into the oil reservoir. In one embodiment, the aqueous flood comprises an alkali or alkaline agent in an amount from 0.01 to 2.0 wt %, e.g., from 0.05 to 1.5 wt % or from 0.01 to 1 wt %, based on the total mass of the aqueous flood.

In addition, the aqueous flood may comprise a co-surfactant. Suitable co-surfactants for use with surfactant mixtures of the present invention include primary, secondary, or tertiary alcohols, an alcohol ether, a polyalkylene glycol, a poly(oxyalkylene)glycol, a poly(oxyalkylene)glycol ether or mixtures thereof. The poly(oxyalkylene)gylcol ether may be any C₁-C₈ mono-alkyl ether, such as ethylene or propylene glycol mono-alkyl or mono-phenyl ether, a di-ethylene or di-propylene glycol mono-alkyl or mono-phenyl ether, a tri-ethylene or tri-propylene glycol mono-alkyl or mono-phenyl ether, polyethylene glycol mono-phenyl ether, polypropylene glycol mono-phenyl ether or mixtures thereof. Examples of the poly(oxyalkylene) glycol are poly(oxyethylene) glycol and poly(oxypropylene) glycol or mixtures thereof. In one embodiment, the aqueous flood comprises a co-surfactant in an amount from 0.01 to 2.0 wt %, e.g. from 0.05 to 1.5 wt % or from 0.01 to 1 wt %, based on the total mass of the aqueous flood.

It should be understood that the balance, e.g., about 93 to 99.9 wt %, of the aqueous flood may comprise water and/or hydrocarbons. The composition of the surfactant composition employed, and more importantly the oil-soluble surfactant, may vary depending on the type of crude oil in the ground. For light crude oil having an API (American Petroleum Institute) gravity greater than 31.1°, oil soluble surfactants with more aliphatic groups may be desired. For medium crude oil having an API gravity between 22.3° API and 31.1° API, oil soluble surfactants with a mixture of aromatic and aliphatic groups may be desired. For heavy crude oil having an API gravity less than 22.3° API, oil soluble surfactants with aromatic groups may be desired.

### Enhanced Oil Recovery

In one embodiment of the present invention, the surfactant composition, e.g., syn-nat or syn-syn surfactant composition, is made by the following process. First at least two surfactants, one being a water-soluble surfactant (preferably synthetic) and the other being an oil-soluble surfactant (natural or synthetic), are mixed thoroughly at a temperature of from 40° C. to 80° C., e.g., from 50° C. to 70° C. or from 60 to 70° C. While mixing, one or more of additional oil co-surfactant, and/or polymer optionally are stirred into the surfactant mixture. The surfactant mixture may then be combined with an alkali or alkaline agent.

In another embodiment, a linear alkylaryl alkylate is blended with a second alkylate, at ratio of from 9:1 to 1:9, e.g., from 8:2 to 2:8 or from 7:3 to 3:7, such that the final molecular weight of the mixed alkylates is between 220 and 420, and co-sulfonated by SO₃ followed by neutralization with sodium hydroxide to form a blend.

After the surfactant mixture is formed, water is blended with the surfactant mixture such that the concentration of the surfactant mixture is from 0.1 wt % to 5 wt %, e.g., from 0.2 wt % to 3 wt % or from 0.5 wt % to 1.5 wt %, and the resulting aqueous flood is pumped into the oil reservoir. For those surfactant mixtures made without an alkali or alkaline agent prior to being pumped into the oil reservoir, the alkali or alkaline agent may be pumped into the oil reservoir after the aqueous flood is pumped into the reservoir. At that point, neutralization occurs in situ. The aqueous flood interacts with entrained oil such that the flood releases the crude oil so that the released crude oil may be recovered.

The present invention may be carried out using injection and production systems as defined by any suitable arrangement of wells. For illustration purposes, one exemplary well arrangement commonly used in waterflooding operations and suitable for use in carrying out the oil recovery processes of the present invention involve two wells. The aqueous flooding is injected into one well and oil is recovered from a second adjacent well. Of course, other well arrangements may be used in carrying out the present invention.

In general, the process may involve the use of a sacrificial slug when the oil reservoir contains divalent metal ions, i.e. calcium and magnesium. Example of suitable sacrificial agents in the sacrificial slug include chelating compounds, such as lignosulfonates, lignosulfonate-acrylic acid graft copolymers, alkylsulfonated phenol/aldehyde resins, sulfomethylated lignite salt, low molecular weight polyalkylene glycols, polyamines, asphaltenes, alkoxylated asphalt, etc. In one such embodiment, the sacrificial slug is pumped into the well before a surfactant composition of the present invention. In another embodiment, the sacrificial slug may be combined with the surfactant slug the present invention. Next, the surfactant slug is injected into the well and is followed by a driving slug, typically water, that pushes the released crude oil to the second well so that it may be recovered. A thickening slug may be used together with the surfactant slug or following the surfactant slug to control the mobility of the surfactant slug through the oil reservoir. Depending on the size of the oil reservoir it may take from weeks to months, even years to recover the oil with an enhancing oil recovery with surfactant mixtures of the present invention.

### EXAMPLES

### Phase Behavior Test Conditions

Each of the following examples was conducted under the following conditions. 5 mL of crude oil was combined with 5 mL of a surfactant composition in a 10 mL graduated cylinder. The composition of the surfactant compositions are provided in each example, with the balance of the surfactant compositions being water and/or hydrocarbons. The cylinder was plugged with a rubber stopper and each example was mixed by vigorous shaking. The examples were allowed to age in an explosion-proof oven for 1 week at room temperatures. For each example, multiple runs were conducted with a gradient of NaOH. After aging each example separated into two phases, and the lower phase was tested for color and clarity. Also the volume was measured and a phase type was determined.

Color was determined using the following color codes: B=brown, C=Clear, G=grey, M=milky, W=White, Y=Yellow, L=light and D=Dark.

Clarity was determined using the following clarity codes: Cl=Clear, Tr=Translucent, Op=Opaque, and PPT=precipitate.

Phase type was determined using the following phase type codes:

II: Two fluid envelopes exist—a bottom aqueous phase and a top oil phase. No color is visible in the aqueous phase. The crude oil and aqueous phase volumes are equal to the volumes placed in the tube. Either the alkali has generated no visible surfactant or the surfactant have been driven into the crude oil and no crude oil swelling has taken place (Type II+phase behavior).

II−: Two fluid envelopes exist—a bottom aqueous phase and an oil phase. The bottom aqueous phase is colored indicating the alkali has saponified acids in the crude oil which are now present in the aqueous phase. The crude volume can be swollen due to the interaction with the surfactant (added and in-situ), but this is not a requirement for this designation.

III: Three or more fluid envelopes exist—a bottom aqueous phase, one or more middle emulsion phases, and a top crude oil phase. The aqueous phase can be colored with saponified acids from the crude oil; however, this does not necessarily have to be the case.

II+: Two fluid envelopes exist—a bottom aqueous phase and a top crude oil phase. The bottom aqueous phase is clear because the surfactant (added and in-situ) reside in the crude oil phase. The crude oil phase is swollen due to surfactant carrying water into the crude oil phase.

Type III is considered to have the best probability of recovering additional oil. Type II is considered to have the poorest chance to recover additional oil. Type II− is considered to have the second best chance to recover additional oil because it shows interaction between the aqueous phase and crude oil and saponified acids are observed. Even though Type II+ demonstrates interaction between the crude oil and the aqueous phase, it is considered to have poorer oil recovery potential than Type II−.

### EXAMPLE 1

### Syn/Nat with Light Crude

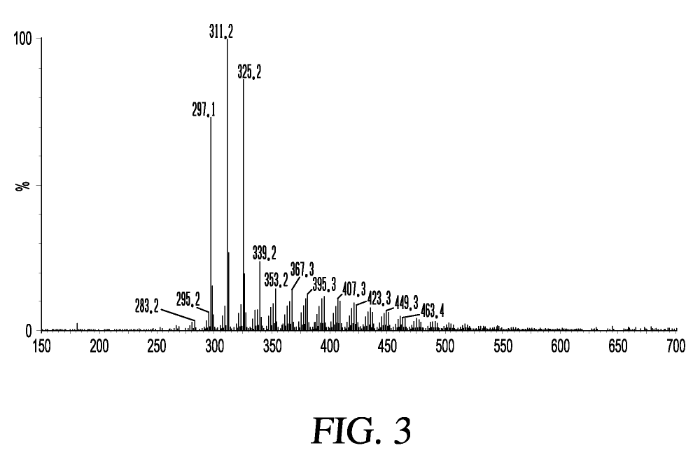

A surfactant composition of a synthetic linear alkylaryl anionic sulfonate and a petroleum sulfonate were mixed according the phase behavior conditions described above with a light crude oil (API=44.1°). The synthetic linear alkylaryl anionic sulfonate was Witconic™ 1298 soft acid sodium salt, a dodecylybenzene sulfonic acid sodium salt. The petroleum surfactant was Petronate HL. The polymer used was Flopaam™ 3230S made by SNF. The Witconic™ 1298 soft acid sodium salt and petroleum surfactant were mixed at a ratio of 40:60. The molecular weight of the blend is 410. The molecular weight distribution of this surfactant composition is shown in FIG. 3.

Table 1 indicates the results for five runs with different amounts of NaOH in the surfactant composition.

TABLE 1
Syn/Nat in Light Crude

| | Run | | | | |
|---|---|---|---|---|---|
| | 1a | 1b | 1c | 1d | 1e |
| API = 44.1° (mL) | 5.0 | 5.0 | 5.0 | 5.0 | 5.0 |
| Surfactant Composition | 5.0 | 5.0 | 5.0 | 5.0 | 5.0 |
| (mL) | | | | | |
| Surfactant Composition | | | | | |
| Surfactants | 0.10% | 0.10% | 0.10% | 0.10% | 0.10% |
| 1298 | 40% | 40% | 40% | 40% | 40% |
| Petronate HL | 60% | 60% | 60% | 60% | 60% |
| Flopaam 3230S | 0.10% | 0.10% | 0.10% | 0.10% | 0.10% |
| NaOH | 0% | 0.5% | 1.0% | 1.5% | 2.0% |
| NaCl | 0.10% | 0.10% | 0.10% | 0.10% | 0.10% |
| Na₂SO₄ | 0.05% | 0.05% | 0.05% | 0.05% | 0.05% |
| Results of Lower Phase | | | | | |
| Phase Type | III | II- | II- | II- | II- |
| Color | C | C | L | L | C |
| Clarity | Cl | Cl | Cl | Tr | Cl |
| Volume (mL) | 4.7 | 5.0 | 5.0 | 5.0 | 5.0 |

### EXAMPLE 2

### Oil Soluble Sodium sulfonate alone with Light Crude

A surfactant composition comprising a synthetic oil-soluble sulfonate were mixed according the phase behavior conditions described above with a light crude oil (API=44.1°). The synthetic sulfonate was sulfonic acid sodium salt of H-250 with a molecular weight of 430. The results are shown in Table 2 below.

TABLE 2
Oil soluble sodium sulfonate in Light Crude

| | Run | | | | |
|---|---|---|---|---|---|
| | 1a | 1b | 1c | 1d | 1e |
| API = 44.1° (mL) | 5.0 | 5.0 | 5.0 | 5.0 | 5.0 |
| Surfactant Composition | 5.0 | 5.0 | 5.0 | 5.0 | 5.0 |
| (mL) | | | | | |
| Surfactant Composition | | | | | |
| Surfactants | 0.10% | 0.10% | 0.10% | 0.10% | 0.10% |
| Water-Soluble | 0% | 0% | 0% | 0% | 0% |
| H-250 | 100% | 100% | 100% | 100% | 100% |
| Flopaam 3230S | 0.10% | 0.10% | 0.10% | 0.10% | 0.10% |
| NaOH | 0% | 0.5% | 1.0% | 1.5% | 2.0% |
| NaCl | 0.10% | 0.10% | 0.10% | 0.10% | 0.10% |
| Na₂SO₄ | 0.05% | 0.05% | 0.05% | 0.05% | 0.05% |
| Results of Lower Phase | | | | | |
| Phase Type | III | II | II | II | II |
| Color | C | C | C | C | C |
| Clarity | Cl | Tr | Cl | Cl | Cl |
| Volume (mL) | 5.0 | 5.0 | 5.0 | 5.0 | 5.0 |

### EXAMPLE 3

### Syn/Syn with Light Crude

A surfactant composition comprising Witconic™ 1298 soft acid sodium salt and a synthetic oil-soluble sulfonate were mixed according the phase behavior conditions described above with a light crude oil (API=44.1°). The synthetic sulfonate was sulfonic acid sodium salt of H-250. soft acid sodium salt and sulfonic acid sodium salt of H-250 were mixed at a ratio of 20:80. The molecular weight of the blend is 410. The results are shown in Table 3 below.

TABLE 3
Syn/Syn in Light Crude

| | Run | | | | |
|---|---|---|---|---|---|
| | 1a | 1b | 1c | 1d | 1e |
| API = 44.1° (mL) | 5.0 | 5.0 | 5.0 | 5.0 | 5.0 |
| Surfactant Composition | 5.0 | 5.0 | 5.0 | 5.0 | 5.0 |
| (mL) | | | | | |
| Surfactant Composition | | | | | |
| Surfactants | 0.10% | 0.10% | 0.10% | 0.10% | 0.10% |
| 1298 | 20% | 20% | 20% | 20% | 20% |
| H-250 | 80% | 80% | 80% | 80% | 80% |
| Flopaam 3230S | 0.10% | 0.10% | 0.10% | 0.10% | 0.10% |
| NaOH | 0% | 0.5% | 1.0% | 1.5% | 2.0% |
| NaCl | 0.10% | 0.10% | 0.10% | 0.10% | 0.10% |
| Na₂SO₄ | 0.05% | 0.05% | 0.05% | 0.05% | 0.05% |
| Results of Lower Phase | | | | | |
| Phase Type | III | III | II | II | II |
| Color | C | C | L | L | L |
| Clarity | Cl | Cl | Cl | Cl | Cl |
| Volume (mL) | 5.0 | 5.0 | 5.0 | 5.0 | 5.0 |

### EXAMPLE 4

### Syn/Syn with Light Crude

A surfactant composition comprising Witconic™ 1298 soft acid sodium salt and a synthetic oil-soluble sulfonate were mixed according the phase behavior conditions described above with a light crude oil (API=44.1°). The synthetic sulfonate was sulfonic acid sodium salt of H-250 The Witconic™ 1298 soft acid sodium salt and sulfonic acid sodium salt of H-250 were mixed at a ratio of 80:20. The molecular weight of the blend is 350. The molecular weight distribution of this surfactant composition is shown in FIG. 4. The results are shown in Table 4 below.

TABLE 4
Oil soluble sodium sulfonate in Light Crude

| | Run | | | | |
|---|---|---|---|---|---|
| | 1a | 1b | 1c | 1d | 1e |
| API = 44.1° (mL) | 5.0 | 5.0 | 5.0 | 5.0 | 5.0 |
| Surfactant Composition | 5.0 | 5.0 | 5.0 | 5.0 | 5.0 |
| (mL) | | | | | |
| Surfactant Composition | | | | | |
| Surfactants | 0.10% | 0.10% | 0.10% | 0.10% | 0.10% |
| 1298 | 80% | 80% | 80% | 80% | 80% |
| H-250 | 20% | 20% | 20% | 20% | 20% |
| Flopaam 3230S | 0.10% | 0.10% | 0.10% | 0.10% | 0.10% |
| NaOH | 0% | 0.5% | 1.0% | 1.5% | 2.0% |
| NaCl | 0.10% | 0.10% | 0.10% | 0.10% | 0.10% |
| Na₂SO₄ | 0.05% | 0.05% | 0.05% | 0.05% | 0.05% |
| Results of Lower Phase | | | | | |
| Phase Type | III | III | III | III | III |
| Color | C | C | C | C | C |
| Clarity | Cl | Tr | Tr | Tr | Tr |
| Volume (mL) | 4.6 | 5.0 | 5.0 | 5.0 | 5.0 |

### EXAMPLE 5

### Syn/Nat with Medium Crude

The surfactant compositions described above in Example 1 were mixed with a medium crude oil (API=29.0°). The results are shown in Table 5.

TABLE 5
Syn/Nat in Medium Crude

| | Run | | | | |
|---|---|---|---|---|---|
| | 5a | 5b | 5c | 5d | 5e |
| API = 29.0° (mL) | 5.0 | 5.0 | 5.0 | 5.0 | 5.0 |
| Surfactant Composition | 5.0 | 5.0 | 5.0 | 5.0 | 5.0 |
| (mL) (From Example 1) | | | | | |
| Results of Lower Phase | | | | | |
| Phase Type | III | II- | II- | II- | II- |
| Color | C | L | L | L | L |
| Clarity | Cl | Cl | Cl | Cl | Cl |
| Volume (mL) | 3.3 | 5.0 | 5.0 | 5.0 | 5.0 |

### EXAMPLE 6

### Oil Soluble Syn Alone with Medium Crude

The surfactant compositions described above in Example 2 were mixed with a medium crude oil (API=29.0°). The results are shown in Table 6.

TABLE 6
Oil soluble sodium sulfonate in Medium Crude

| | Run | | | | |
|---|---|---|---|---|---|
| | 6a | 6b | 6c | 6d | 6e |
| API = 29.0° (mL) | 5.0 | 5.0 | 5.0 | 5.0 | 5.0 |
| Surfactant Composition | 5.0 | 5.0 | 5.0 | 5.0 | 5.0 |
| (mL) (From Example 2) | | | | | |
| Results of Lower Phase | | | | | |
| Phase Type | III | II | III | III | III |
| Color | L | L | L | L | L |
| Clarity | Cl | Tr | Tr | Tr | Tr |
| Volume (mL) | 4.7 | 5.0 | 5.0 | 5.0 | 5.0 |

### EXAMPLE 7

### Syn/Syn with Medium Crude

The surfactant compositions described above in Example 3 were mixed with a medium crude oil (API=29.0°). The results are shown in Table 7.

TABLE 7
Syn/Syn in Medium Crude

| | Run | | | | |
|---|---|---|---|---|---|
| | 7a | 7b | 7c | 7d | 7e |
| API = 29.0° (mL) | 5.0 | 5.0 | 5.0 | 5.0 | 5.0 |
| Surfactant Composition | 5.0 | 5.0 | 5.0 | 5.0 | 5.0 |
| (mL) (From Example 3) | | | | | |
| Results of Lower Phase | | | | | |
| Phase Type | III | III | II- | II- | II- |
| Color | C | Y | Y | Y | Y |
| Clarity | Cl | Cl | Cl | Cl | Cl |
| Volume (mL) | 3.2 | 4.6 | 5.0 | 5.0 | 5.0 |

### EXAMPLE 8

### Syn/Syn with Medium Crude

The surfactant compositions described above in Example 4 were mixed with a medium crude oil (API=29.0°). The results are shown in Table 8.

TABLE 8
Syn/Syn in Medium Crude

| | Run | | | | |
|---|---|---|---|---|---|
| | 8a | 8b | 8c | 8d | 8e |
| API = 29.0° (mL) | 5.0 | 5.0 | 5.0 | 5.0 | 5.0 |
| Surfactant Composition | 5.0 | 5.0 | 5.0 | 5.0 | 5.0 |
| (mL) (From Example 4) | | | | | |
| Results of Lower Phase | | | | | |
| Phase Type | III | III | III | III | III |
| Color | C | B | Y | Y | Y |
| Clarity | Cl | Tr | Tr | Tr | PPT |
| Volume (mL) | 3.6 | 4.9 | 5.0 | 5.0 | 5.0 |

The data from Examples 1-8, indicates that the syn-syn composition of Example 4 is very effective as a surfactant to be used in enhanced oil recovery for both light and medium crude oil.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A surfactant composition comprising:
a water-soluble surfactant having an equivalent weight of from 200 to 460, wherein at least 60% of the water-soluble surfactant has a molecular weight within 15 g/mole of the equivalent weight of the water-soluble surfactant; and
an oil-soluble surfactant having an equivalent weight of 300 to 700 moles, wherein less than 40% of the oil-soluble surfactant has a molecular weight within 15 g/mole of the equivalent weight of the oil-soluble surfactant.

2. The composition of claim 1, wherein more than 70% of the water-soluble surfactant has a molecular weight within 15 g/mole of the molecular weight of the water-soluble surfactant.

3. The composition of claim 1, wherein less than 30% of the oil-soluble surfactant has a molecular weight within 15 g/mole of the equivalent weight of the oil-soluble surfactant.

4. The composition of claim 1, wherein the composition is capable of lowering interfacial tension of crude oil in an oil reservoir to less than 0.01 dynes/cm.

5. The composition of claim 1, wherein the water-soluble surfactant is selected from the group consisting of linear alkylbenzene sulfonates, linear alkyltoluene sulfonates, linear alkylxylene sulfonates, and linear alpha olefin sulfonates.

6. The composition of claim 1, wherein the oil-soluble surfactant is selected from the group consisting of petroleum sulfonates, linear alkylaryl and dialkylaryl sulfonates, branched alkylaryl and dialkylaryl sulfonates, linear alkane sulfonates, and branched alkane sulfonates.

7. The composition of claim 1, wherein the surfactant composition has an overall equivalent weight of from 300 to 500 g/mole.

8. The composition of claim 1, wherein the weight ratio of water-soluble surfactant to the oil-soluble surfactant is from 9:1 to 1:9.

9. The composition of claim 1, further comprising one or more additional components selected from the group consisting of:
an alkali or alkaline agent;
a polymer selected from the group consisting of poly(acrylamide), poly(acrylic acid) alkali metal salt, and partially hydrolyzed poly (acrylamide); and
a co-surfactant selected from the group consisting of primary alcohols, secondary alcohols, tertiary alcohols, alcohol ethers, polyalkylene glycols, poly(oxyalkylene) glycols, and poly(oxyalkylene)glycol ethers.

10. A surfactant composition comprising:
a water-soluble surfactant having an equivalent weight of 200 to 460; and
an oil-soluble surfactant having an equivalent weight of 300 to 700, wherein the molecular weight distribution of the water-soluble surfactant is narrower than the molecular weight distribution of the oil-soluble surfactant.

11. A method for recovering entrained crude oil from an oil reservoir, the method comprising:
(a) injecting into the oil reservoir a surfactant composition comprising 3
(i) water;
(ii) a water-soluble surfactant having an equivalent weight of 200 to 460, wherein at least 60% of the water-soluble surfactant has a molecular weight within 15 g/mole of the equivalent weight of the water-soluble surfactant; and
(iii) an oil-soluble surfactant having an equivalent weight of 300 to 700, wherein less than 40% of the oil-soluble surfactant has a molecular weight within 15 g/mole of the equivalent weight of the oil-soluble surfactant; and
(b) displacing the entrained crude oil with the surfactant composition.

12. A surfactant composition comprising:
a synthetic linear alkylaryl anionic surfactant having an equivalent weight of 200 to 460, wherein at least 60% of the synthetic linear alkylaryl anionic surfactant has a molecular weight within 15 g/mole of the equivalent weight of the synthetic linear alkylaryl anionic surfactant; and
a petroleum surfactant having an equivalent weight of 300 to 700, wherein less than 40% of the petroleum surfactant has a molecular weight within 15 g/mole of the equivalent weight of the petroleum surfactant.

13. The composition of claim 12, wherein the ratio of the synthetic linear alkylaryl surfactant to the petroleum surfactant is from 9:1 to 1:9.

14. The composition of claim 12, wherein the composition is capable of lowering interfacial tension of crude oil in an oil reservoir to less than 0.01 dynes/cm.

15. The composition of claim 12, wherein the synthetic linear alkylaryl anionic surfactant is selected from the group consisting of linear alkylbenzene sulfonates, linear alkyltoluene sulfonates, linear alkylxylene sulfonates, and linear alpha olefin sulfonates.

16. The composition of claim 12, further comprising one or more additional components selected from the group consisting of:
an alkali or alkaline agent;
a polymer selected from the group consisting of poly(acrylamide), poly(acrylic acid) alkali metal salt, and partially hydrolyzed poly (acrylamide); and
a co-surfactant selected from the group consisting of primary alcohols, secondary alcohols, tertiary alcohols, alcohol ethers, polyalkylene glycols, poly(oxyalkylene) glycols, and poly(oxyalkylene)glycol ethers.

17. A surfactant composition for enhanced oil recovery comprising:
a synthetic linear alkylaryl anionic surfactant having an equivalent weight of 200 to 460; and
a petroleum surfactant having an equivalent weight of 300 to 700, wherein the molecular weight distribution of the synthetic linear alkylaryl anionic surfactant is narrower than the molecular weight distribution of the petroleum surfactant.

18. A method for recovering entrained crude oil from an oil reservoir, the method comprising:
(a) injecting into the oil reservoir a surfactant composition comprising:
(i) water;
(ii) a synthetic linear alkylaryl anionic surfactant having an equivalent weight of 200 to 460, wherein at least 60% of the synthetic linear alkylaryl anionic surfactant has a molecular weight within 15 g/mole of the equivalent weight of the synthetic linear alkylaryl anionic surfactant; and
(iii) a petroleum surfactant having an equivalent weight of 300 to 700, wherein less than 40% of the petroleum surfactant has a molecular weight within 15 g/mole of the equivalent weight of the petroleum surfactant; and
(b) displacing the entrained crude oil with the surfactant composition.

19. A surfactant composition comprising:
a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and
a second synthetic surfactant having an equivalent weight of 300 to 700, wherein less than 40% of the second synthetic surfactant has a molecular weight within 15 g/mole of the equivalent weight of the second synthetic surfactant.

20. The composition of claim 19, wherein the ratio of the first synthetic surfactant to the second synthetic surfactant is from 9:1 to 1:9.

21. The composition of claim 19, wherein the composition is capable of lowering interfacial tension of crude oil in an oil reservoir to less than 0.01 dynes/cm.

22. The composition of claim 19, wherein the first synthetic linear alkylaryl anionic surfactant is selected from the group consisting of linear alkylbenzene sulfonates, linear alkyltoluene sulfonates, linear alkylxylene sulfonates, and linear alpha olefin sulfonates.

23. The composition of claim 19, wherein the second synthetic surfactant is selected from the group consisting of linear alkylaryl and dialkylaryl sulfonates, branched alkylaryl and dialkylaryl sulfonates, linear alkane sulfonates, and branched alkane sulfonates.

24. The composition of claim 19, further comprising one or more additional components selected from the group consisting of:
an alkali or alkaline agent;
a polymer selected from the group consisting of poly(acrylamide), poly(acrylic acid) alkali metal salt, and partially hydrolyzed poly (acrylamide); and
a co-surfactant selected from the group consisting of primary alcohols, secondary alcohols, tertiary alcohols, alcohol ethers, polyalkylene glycols, poly(oxyalkylene) glycols, and poly(oxyalkylene)glycol ethers.

25. A surfactant composition comprising:
a first synthetic linear alkylaryl anionic surfactant having an equivalent weight of 200 to 460; and
a second synthetic surfactant having an equivalent weight of 300 to 700, wherein the molecular weight distribution of the first synthetic linear alkylaryl anionic surfactant is narrower than the molecular weight distribution of the second synthetic surfactant.

26. A method for recovering entrained crude oil from an oil reservoir, the method comprising:
(a) injecting into the oil reservoir a surfactant composition comprising:
(i) water;
(ii) a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and
(iii) a second synthetic surfactant having an equivalent weight of 300 to 700, wherein less than 40% of the second synthetic surfactant has a molecular weight within 15 g/mole of the equivalent weight of the second synthetic surfactant; and
(b) displacing the entrained crude oil with the surfactant composition.

27. A surfactant composition comprising:
a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and
a second synthetic surfactant having an equivalent weight of 300 to 700, and selected from the group consisting of linear alkylaryl sulfonates, linear dialkylaryl sulfonates and linear alkane sulfonates.

28. The composition of claim 27, wherein the ratio of the first synthetic surfactant to the second synthetic surfactant is from 9:1 to 1:9.

29. The composition of claim 27, wherein the composition is capable of lowering interfacial tension of crude oil in an oil reservoir to less than 0.01 dynes/cm.

30. The composition of claim 27, wherein the first synthetic linear alkylaryl anionic surfactant is selected from the group consisting of linear alkylbenzene sulfonates, linear alkyltoluene sulfonates, linear alkylxylene sulfonates, and linear alpha olefin sulfonates.

31. The composition of claim 27, further comprising one or more additional components selected from the group consisting of:
an alkali or alkaline agent;
a polymer selected from the group consisting of poly(acrylamide), poly(acrylic acid) alkali metal salt, and partially hydrolyzed poly (acrylamide); and
a co-surfactant selected from the group consisting of primary alcohols, secondary alcohols, tertiary alcohols, alcohol ethers, polyalkylene glycols, poly(oxyalkylene) glycols, and poly(oxyalkylene)glycol ethers.

32. A method for recovering entrained crude oil from an oil reservoir, the method comprising:
(a) injecting into the oil reservoir a surfactant composition comprising:
(i) water;
(ii) a first synthetic linear alkylaryl anionic surfactant having an equivalent weight of 200 to 460, wherein at least 60% of the first synthetic linear alkylaryl anionic surfactant has a molecular weight within 15 g/mole of the equivalent weight of the first synthetic linear alkylaryl anionic surfactant; and
(iii) a second synthetic surfactant having an equivalent weight of 300 to 700, and selected from the group consisting of linear alkylaryl sulfonates, linear dialkylaryl sulfonates and linear alkane sulfonates; and
(b) displacing the entrained crude oil with the surfactant composition.
